(19) United States
(12) Patent Application Publication
(10) Pub. No.: US 2023/0176459 A1
(43) Pub. Date: Jun. 8, 2023

(54) LIGHT SOURCE DEVICE WITH HEAT DISSIPATION FUNCTION AND PROJECTOR THEREOF

(71) Applicant: BENQ CORPORATION, Taipei (TW)

(72) Inventors: Chun-Han Lin, Taipei (TW); Chen-Cheng Huang, Taipei (TW)

(73) Assignee: BENQ CORPORATION, Taipei (TW)

(21) Appl. No.: 17/723,483

(22) Filed: Apr. 19, 2022

(30) Foreign Application Priority Data
Dec. 6, 2021 (TW) 110145434

(51) Int. Cl. G03B 21/16

(52) U.S. Cl. CPC G03B 21/16

(57) ABSTRACT

A light source device with a heat dissipation function applied to a projector includes a light source, a heat conduction plate, a flow guide member, and a fluid driving device. The heat conduction plate is disposed on the light source and has a hole structure corresponding to a hot spot region of the light source. The flow guide member has a guide channel corresponding to the hole structure. The guide channel has wide inlet and a narrow outlet. The flow guide member is disposed on the heat conduction plate to make the narrow outlet aligned with the hole structure. The fluid driving device is disposed on the flow guide member and communicated with the wide inlet. The fluid driving device drives fluid to flow from the wide inlet into the guide channel and then pass through the narrow outlet for generating an impact flow toward the hole structure.

### BACKGROUND OF THE INVENTION

### 1. Field of the Invention

The present invention relates to a light source device with a heat dissipation function and a projector thereof, and more specifically, to a light source device utilizing an impact flow to perform heat dissipation on a projector light source and a projector thereof.

### 2. Description of the Prior Art

For a projector utilizing a solid-state light source, such as a laser projector, there is usually a heat dissipation module disposed in the projector for performing heat dissipation on the solid-state light source since internal heat energy is often accumulated in the solid-state light source. A conventional heat dissipation design is to attach one end of a heat pipe to the solid-state light source and dispose a heat dissipation fan on another end of the heat pipe. Accordingly, the heat energy generated by the solid-state light source could be transmitted to the heat dissipation fan via the heat pipe and could be taken away by a heat dissipation airflow generated by the heat dissipation fan, so as to reduce a working temperature of the solid-state light source.

However, since the aforesaid heat dissipation design only indirectly transmits the heat energy to the heat dissipation fan via the heat pipe without directly performing high-efficient heat dissipation on the solid-state light source in a short distance, it may cause the problem that an excessively high temperature of the solid-state light source occurs easily due to poor heat dissipation efficiency, so as to considerably influence the utilization safety, operational stability, and service life of the projector.

### SUMMARY OF THE INVENTION

The present invention provides a light source device with a heat dissipation function applied to a projector. The light source device includes a light source, a heat conduction plate, a flow guide member, and a fluid driving device. The light source has at least one hot spot region. The heat conduction plate is disposed on the light source and has a hole structure corresponding to the at least one hot spot region. The flow guide member has a guide channel corresponding to the hole structure and has a wide inlet and a narrow outlet. The flow guide member is disposed on the heat conduction plate to make the narrow outlet aligned with the hole structure. The fluid driving device is disposed on the flow guide member and communicated with the wide inlet. The fluid driving device drives a fluid to flow into the guide channel via the wide inlet and then pass through the narrow outlet for generating an impact flow toward the hole structure.

The present invention further provides a projector with a heat dissipation function. The projector includes a projector body and a light source device. The light source device is disposed in the projector body. The light source device includes a light source, a heat conduction plate, a flow guide member, and a fluid driving device. The light source has at least one hot spot region. The heat conduction plate is disposed on the light source and has a hole structure corresponding to the at least one hot spot region. The flow guide member has a guide channel corresponding to the hole structure and has a wide inlet and a narrow outlet. The flow guide member is disposed on the heat conduction plate to make the narrow outlet aligned with the hole structure. The fluid driving device is disposed on the flow guide member and communicated with the wide inlet. The fluid driving device drives a fluid to flow into the guide channel via the wide inlet and then pass through the narrow outlet for generating an impact flow toward the hole structure.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a projector according to an embodiment of the present invention.

FIG. 2 is a diagram of a light source device located in a projector body in FIG. 1.

FIG. 3 is a cross-sectional diagram of the light source device in FIG. 2 along a cross-sectional line A-A.

FIG. 4 is a diagram of a heat conduction plate integrally formed with a flow guide member being disposed on a light source according to another embodiment of the present invention.

FIG. 5 is a cross-sectional diagram of the heat conduction plate and the flow guide member in FIG. 4 along a cross-sectional line B-B.

FIG. 6 is a cross-sectional diagram of the heat conduction plate and the flow guide member in FIG. 4 along a cross-sectional line C-C.

### DETAILED DESCRIPTION

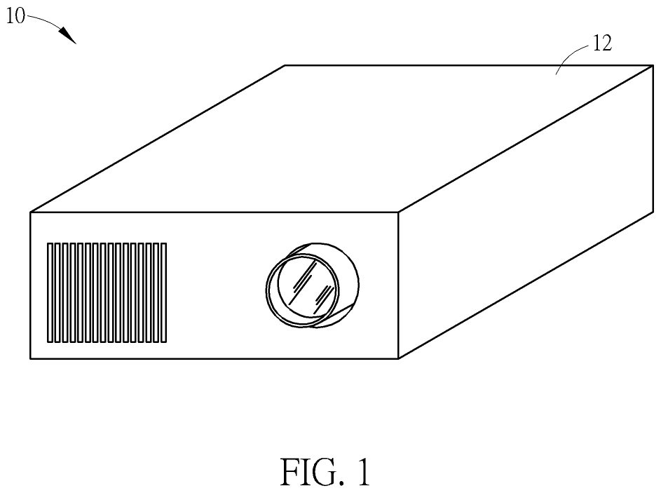

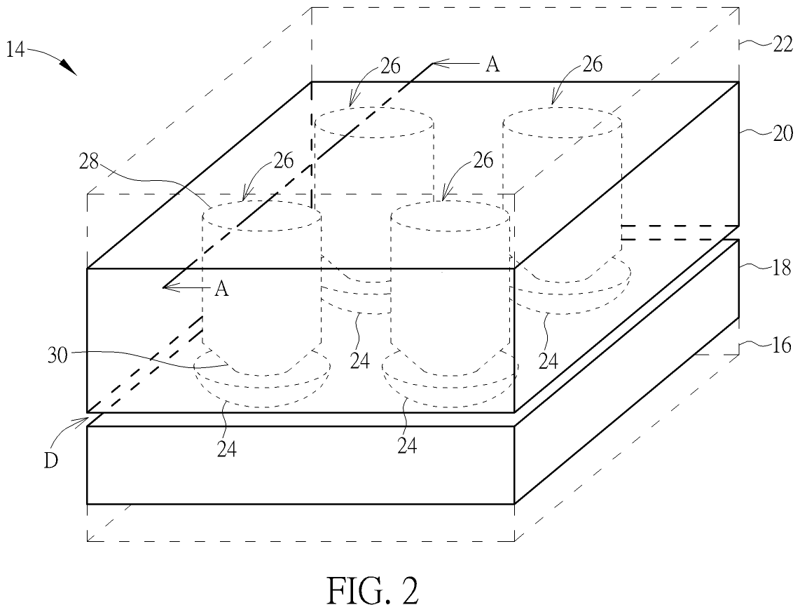

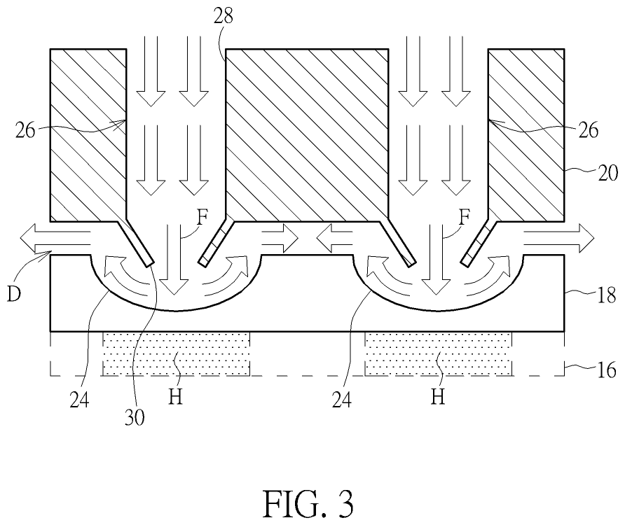

Please refer to FIG. 1, FIG. 2, and FIG. 3. FIG. 1 is a diagram of a projector 10 according to an embodiment of the present invention. FIG. 2 is a diagram of a light source device 14 located in a projector body 12 in FIG. 1. FIG. 3 is a cross-sectional diagram of the light source device 14 in FIG. 2 along a cross-sectional line A-A. As shown in FIG. 1, FIG. 2, and FIG. 3, the projector 10 could be a conventional projector apparatus (e.g. a laser projector, but not limited thereto) utilizing a solid-sate light source to generate color light. The projector 10 includes the projector body 12 and the light source device 14. The projector body 12 could include major projector components disposed in a projector, such as a projector lens and a digital micromirror device (DMD), and the related description is omitted herein since it is commonly seen in the prior art.

As shown in FIG. 1, FIG. 2, and FIG. 3, the light source device 14 is disposed in the projector body 12 for providing projection light of the projector body 12. The light source device 14 includes a light source 16 (briefly depicted by dotted lines), a heat conduction plate 18 (made of heat conduction material, such as metal), a flow guide member 20, and a fluid driving device 22 (briefly depicted by dotted lines). The light source 16 could have at least one hot spot region H (two shown in FIG. 3, such as a region corresponding to a light exit of a projector lens, but not limited thereto). The heat conduction plate 18 is disposed on the light source 16 and has a hole structure 24 corresponding to the hot spot region H. The hole structure 24 could be preferably a blind hole in a semi-spherical shape, but the present invention is not limited thereto, meaning that the present invention could adopt a through hole design in another embodiment. The flow guide member 20 could be preferably made of metal material (but not limited thereto, meaning that the present invention could adopt the design that the flow guide member 20 is made of plastic material in another embodiment). The flow guide member 20 has a guide channel 26 corresponding to the hole structure 24. The guide channel 26 has a wide inlet 28 and a narrow outlet 30. The flow guide member 20 is disposed on the heat conduction plate 18 to make each narrow outlet 30 aligned with the corresponding hole structure 24. The fluid driving device 22 is disposed on the flow guide member 20 and is communicated with the wide inlet 28.

To be more specific, in this embodiment, the guide channel 26 could be a nozzle structure which is wider at the top and narrower at the bottom. The flow guide member 20 is detachably disposed on the heat conduction plate 18 to make the narrow outlet 30 of the nozzle structure located above the hole structure 24 and make the flow guide member 20 spaced away from the heat conduction plate 18 by a gap D. The detachable design of the flow guide member 20 (e.g. a design in which the flow guide member 20 has a hook to be detachably engaged with a slot of the heat conduction plate 18) is commonly seen in the prior art, and the related description is omitted herein. The fluid driving device 22 could be preferably a flow generation device (e.g. a heat dissipation fan) for driving air fluid to generate a heat dissipation airflow, but the present invention is not limited thereto, meaning that the fluid driving device 22 could be a pump for generating a heat dissipation water flow in another embodiment. As for which design is adopted, it depends on the practical application of the present invention.

Via the aforesaid designs, as shown in FIG. 3, the heat dissipation airflow generated by the fluid driving device 22 can flow into the guide channel 26 via the wide inlet 28 and then pass through the narrow outlet 30 for generating an impact flow F toward the hole structure 24. After the impact flow F flows into the hole structure 24, the impact flow F can leave the hole structure 24 from the gap D. As such, the present invention can utilize the jet impingement technology to perform heat dissipation on a heat accumulation region (e.g. the hot spot region H) of the light source 16 via the hole structure 24 of the heat conduction plate 18 for efficiently improving the heat dissipation efficiency of the light source device 14.

In summary, the present invention adopts the design that the fluid driving device drives fluid to flow into the flow guide member and then generate the impact flow toward the hole structure of the heat conduction plate after passing through the guide channel which is wider at the top and narrower at the bottom, so as to perform heat dissipation on the hot spot region of the light source. In such a manner, the present invention can efficiently solve the prior art problem that the excessively high temperature of the light source occurs easily as the prior art does not directly perform high-efficient heat dissipation on the light source in a short distance. Thus, the present invention can greatly improve the utilization safety, operational stability, and service life of the projector.

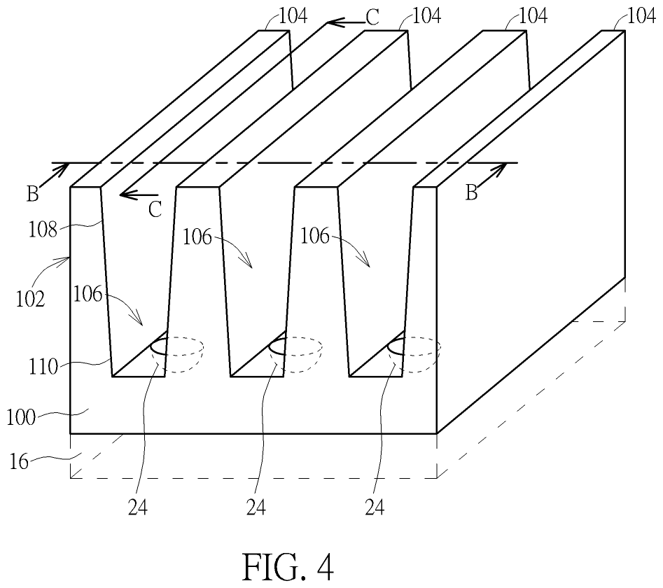

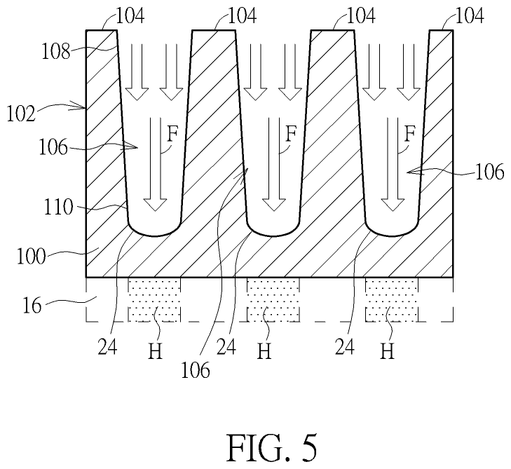

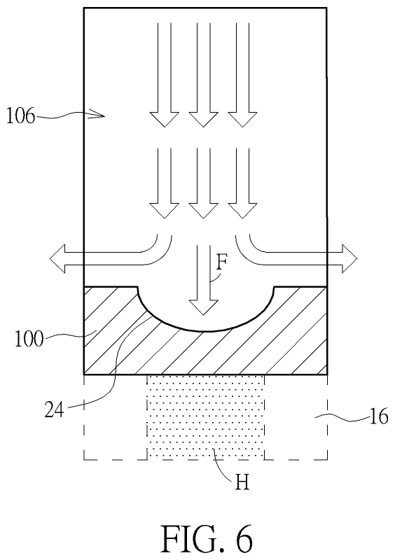

It should be mentioned that the present invention is not limited to the structural design in which the flow guide member is detachably disposed on the heat conduction plate, meaning that the present invention could adopt an integral forming design in another embodiment. For example, please refer to FIG. 4, FIG. 5, and FIG. 6. FIG. 4 is a diagram of a heat conduction plate 100 integrally formed with a flow guide member 102 being disposed on the light source 16 according to another embodiment of the present invention. FIG. 5 is a cross-sectional diagram of the heat conduction plate 100 and the flow guide member 102 in FIG. 4 along a cross-sectional line B-B. FIG. 6 is a cross-sectional diagram of the heat conduction plate 100 and the flow guide member 102 in FIG. 4 along a cross-sectional line C-C. Components both mentioned in this embodiment and the aforesaid embodiment represent components with similar functions or structures, and the related description is omitted herein.

As shown in FIG. 4, FIG. 5, and FIG. 6, the flow guide member 102 includes a plurality of heat dissipation fins 104. The plurality of heat dissipation fins 104 protrudes upward from the heat conduction plate 100. The plurality of heat dissipation fins 104 is arranged side by side to define at least one guide channel 106 (three shown in FIG. 4, but not limited thereto) having a wide inlet 108 and a narrow outlet 110 for connecting the narrow outlet 110 to the hole structure 24. The fluid driving device 22 (not shown in FIGS. 4-6) is disposed on the flow guide member 102 and is communicated with the wide inlet 108.

Via the aforesaid designs, as shown in FIG. 5 and FIG. 6, the heat dissipation airflow generated by the fluid driving device 22 can flow into the guide channel 106 via the wide inlet 108 and then pass through the narrow outlet 110 for generating the impact flow F toward the hole structure 24. After the impact flow F flows into the hole structure 24, the impact flow F can leave the hole structure 24 along the guide channel 106 and then leave the flow guide member 102 from front and back sides of the flow guide member 102, so as to achieve the same heat dissipation effect as mentioned in the aforesaid embodiment for efficiently improving the heat dissipation efficiency of the light source device provided by the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A light source device with a heat dissipation function applied to a projector, the light source device comprising:
a light source having at least one hot spot region;
a heat conduction plate disposed on the light source and having a hole structure corresponding to the at least one hot spot region;
a flow guide member having a guide channel corresponding to the hole structure and having a wide inlet and a narrow outlet, the flow guide member being disposed on the heat conduction plate to make the narrow outlet aligned with the hole structure; and
a fluid driving device disposed on the flow guide member and communicated with the wide inlet, the fluid driving device driving a fluid to flow into the guide channel via the wide inlet and then pass through the narrow outlet for generating an impact flow toward the hole structure.

2. The light source device of claim 1, wherein the guide channel is a nozzle structure, and the flow guide member is detachably disposed on the heat conduction plate to make the narrow outlet of the nozzle structure located above the hole structure and make the flow guide member spaced away from the heat conduction plate by a gap, for allowing the impact flow to flow into the hole structure and then leave the hole structure from the gap.

3. The light source device of claim 2, wherein the flow guide member is made of plastic or metal material.

4. The light source device of claim 1, wherein the flow guide member comprises:
a plurality of heat dissipation fins protruding upward from the heat conduction plate, the plurality of heat dissipation fins being arranged side by side to define the guide channel for connecting the narrow outlet of the guide channel to the hole structure and allowing the impact flow to leave the flow guide member along the guide channel after flowing into the hole structure.

5. The light source device of claim 1, wherein the hole structure is a blind hole or a through hole.

6. The light source device of claim 5, wherein the blind hole is in a semi-spherical shape.

7. The light source device of claim 1, wherein the fluid driving device is a flow generation device or a pump.

8. A projector with a heat dissipation function, the projector comprising:
a projector body; and
a light source device disposed in the projector body, the light source device comprising:
a light source having at least one hot spot region;
a heat conduction plate disposed on the light source and having a hole structure corresponding to the at least one hot spot region;
a flow guide member having a guide channel corresponding to the hole structure and having a wide inlet and a narrow outlet, the flow guide member being disposed on the heat conduction plate to make the narrow outlet aligned with the hole structure; and
a fluid driving device disposed on the flow guide member and communicated with the wide inlet, the fluid driving device driving a fluid to flow into the guide channel via the wide inlet and then pass through the narrow outlet for generating an impact flow toward the hole structure.

9. The projector of claim 8, wherein the guide channel is a nozzle structure, and the flow guide member is detachably disposed on the heat conduction plate to make the narrow outlet of the nozzle structure located above the hole structure and make the flow guide member spaced away from the heat conduction plate by a gap, for allowing the impact flow to flow into the hole structure and then leave the hole structure from the gap.

10. The projector of claim 9, wherein the flow guide member is made of plastic or metal material.

11. The projector of claim 8, wherein the flow guide member comprises:
a plurality of heat dissipation fins protruding upward from the heat conduction plate, the plurality of heat dissipation fins being arranged side by side to define the guide channel for connecting the narrow outlet of the guide channel to the hole structure and allowing the impact flow to leave the flow guide member along the guide channel after flowing into the hole structure.

12. The projector of claim 8, wherein the hole structure is a blind hole or a through hole.

13. The projector of claim 12, wherein the blind hole is in a semi-spherical shape.

14. The projector of claim 8, wherein the fluid driving device is a flow generation device or a pump.
